(19) United States
(12) Patent Application Publication
(10) Pub. No.: US 2007/0132687 A1
(43) Pub. Date: Jun. 14, 2007

(54) ELECTROPHORETIC DISPLAY DEVICE

(75) Inventor: Mark Thomas Johnson, EINDHOVEN (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/576,164

(22) PCT Filed: Oct. 12, 2004
(86) PCT No.: PCT/IB04/52057

§ 371 Date: Apr. 19, 2006

(30) Foreign Application Priority Data
Oct. 24, 2003 (EP) 03103952.2

(51) Int. Cl. G09G 3/36

(52) U.S. Cl. 345/89

(57) ABSTRACT

An electrophoretic display device is driven by application driving waveforms comprising application of various potential differences (R, Gs, P) to bring about a change in image. In the display and method in accordance with the invention the duration of the time period (Δt) in which the end of the transition of one image to another for various waveforms occurs is less than 37.5% of the maximum time period of the waveform (Δ<0.375 tₘₐₓ), and preferably the end of the waveforms are is synchronized in time (Δ=O), i.e. the end of all waveforms occur at the same instance (t_{synchrone}).

The invention relates to an electrophoretic display device comprising electrophoretic particles, an array of display elements comprising a pixel electrode and a counter electrode between which a portion of the electrophoretic particles are present, and control means for supplying one or more potentials differences during a transition period to the electrodes to bring the display elements in a predetermined optical state from a previous optical state to produce an image change.

The invention also relates to a method for driving an electrophoretic display device in which method one or more potential differences are applied to an array of picture elements of the display device within a transition period for providing a change of image on the display device.

A display device of the type mentioned in the opening paragraph is known from the international patent application WO 99/53373. This patent application discloses a electronic ink display comprising two substrates, one of which is transparent, the other substrate is provided with electrodes arranged in row and columns. A crossing between a row and a column electrode is associated with a display element. The display element is coupled to the column electrode via a thin film transistor (TFT), the gate of which is coupled to the row electrode. This arrangements of display elements, TFT transistors and row and column electrode together forms an active matrix. Furthermore, the display element comprises a pixel electrode. A row driver selects a row of display elements and the column driver supply a data signal to the selected row of display elements via the column electrodes and the TFT transistors. The data signals corresponds to graphic data to be displayed.

Furthermore, an electronic ink is provided between the pixel electrode and a common electrode provided on the transparent substrate. The electronic ink comprises multiple microcapsules, of about 10 to 50 microns. Each microcapsule comprises positively charged white particles and negatively charge black particles suspended in a fluid. When a positive field is applied to the pixel electrode, the white particles move to the side of the micro capsule directed to the transparent substrate and the display element becomes visible to a viewer. Simultaneously, the black particles move to the pixel electrode at the opposite side of the microcapsule where they are hidden to the viewer. By applying a negative field to the pixel electrode, the black particles move to the common electrode at the side of the micro capsule directed to the transparent substrate and the display element appears dark to a viewer. When the electric field is removed the display device remains in the acquired state and exhibit a bi-stable character.

Grey scales can be created in the display device by controlling the amount of particles that move to counter electrode at the top of the microcapsules. For example, the energy of the positive or negative electric field, defines as the product of field strength and time of application, controls the amount of particles moving to the top of the microcapsules.

In prior art driving schemes, new images appear in a somewhat irregular manner. The user perceives a new image which appears in an irregular manner across the display, which results in a rather “bitty” image update which is not preferred by the viewer.

It is an object of the invention to provide an electrophoretic display device as described in the opening paragraph in which the appearance of new images is less “bitty”.

To this end the device in accordance with the invention is characterized in that the control means for supplying one or more potential differences to the electrodes are arranged such that the one or more potential differences to bring the display elements in a predetermined optical state to produce an image on the display device substantially end for substantially all elements of the array end for substantially all elements of the array within a time spread period (Δt) less than 75%/2 of the maximum transition period (Δt<0.375tₘₐₓ).

In prior art driving schemes the control means are arranged such that the driving pulse(s), i.e. the potential differences determining the grey scale are initiated at substantially the same time, for example all driving waveforms start to be implemented as soon as an image update signal is issued by the display controller. Although this is a convenient method for driving the display, the inventors have realized that this is a cause for the effect that new images appear in a somewhat irregular manner. The user perceives a new image which appears in an irregular manner across the display, which results in a rather “bitty” image update which is not preferred by the viewer. The different driving waveforms have different durations and for this reason, whilst the image update of all pixels is initiated at substantially the same point in time, the time at which the new image appears varies from element to element dependent of the details of the previous image and the new image, leading to the “bitty” appearance of a new image. Typically, expressed as a percentage of the maximum time period of application of potential differences for bringing an element from one optical state to another in the transition from one image to another, the spread in time (herein called the “time spread period”) is approximately 75% or more of said maximum time period.

In a device and method in accordance with the invention, the one or more potential differences to bring the elements into a predetermined state end the appearance of the new image in all pixels of the display is better synchronized in time within the concept of the invention it holds that, expressed as a percentage of the maximum time period of application of potential differences for bringing an element from one optical state to another in the transition from one image to another, the spread in time is reduced to less than 75%/2 of said maximum time period.

In various embodiments of the invention series of driving waveforms are implemented, all having in common that all driving waveforms are completed at substantially the same reference time, i.e. all ending within a spread in time of less than 75%/2 of the maximum transition period. In this manner, the image update appears more natural to the viewer. Preferably all driving waveforms end within 25% of the maximum transition period, more preferably within a frame period, most preferably the end of all driving waveforms end at the same instance.

It is remarked that as a consequence, not all waveforms will necessarily start at the same point in time.

In respect of preferred embodiments it is remarked that greyscales in electrophoretic displays are generally created by applying voltage differences for specified time periods. They are influenced by image history, dwell time, temperature, humidity, lateral inhomogeneity of the electrophoretic foils etc. Relatively accurate grey levels can be achieved using rail-stabilized approach, which means that the grey levels are always achieved either from reference black or from reference white state. In such driving schemes the transition between one grey level and another is actually often accomplished by a train of pulses, comprising the application of more than one type of potential differences, namely a reset pulse to bring the element to an extreme state, followed by a grey level pulse to bring the element from the extreme state to a determined grey level. Such driving method may use over-reset voltage pulses in which reset pulses largely exceeding the saturation time, i.e. the time required for the ink to switch from its present state to the full white/black saturated state, are used. In addition, to realise the lowest image retention a series of short AC pulses, so called preset pulses, may be supplied prior to the resetting and driving pulse in order to reduce the dwell time and/or image history effects, thus reducing image retention. In general it holds that, the more complex the total driving scheme, the larger the variation in length of the transition time from one image to a next may be between elements, the larger the problem the present invention seeks to overcome becomes and the more advantageous the invention becomes.

In a preferred embodiment the control means are arranged for controlling the one or more potential differences of each of the plurality of picture elements
to be a reset potential difference having a reset value and a reset duration during a reset period,
and subsequently
to be a grey scale potential difference for enabling the particles to occupy the position corresponding to image information such that for substantially all element in the array application of the final grey scale determining potential difference ends at substantially the same instance.

In a further preferred embodiment the control means are arranged for applying an over-reset potential.

An preferred embodiment within this class of embodiments is characterized in that the control means are arranged for controlling the reset potential differences to end at the same time.

All waveforms are then synchronized in respect of the reset pulses.

In a further preferred embodiment the control means are arranged for applying in between the reset potential differences and the grey scale potential differences preset potential differences.

Within the concept of the invention preset potential difference are a series of short AC pulses.

Application of preset potential differences (also called “shaking” pulses) reduces the influence of image history on the image.

Within the concept of the invention “grey scale” is to be understood to mean any intermediate state. When the display is a black and white display, “grey scale” indeed relates to a shade of grey, when other types of colored elements are used ‘grey scale’ is to be understood to encompass any intermediate state in between extreme optical states.

These and other aspects of the display panel of the invention will be further elucidated and described with reference to the drawings, in which:

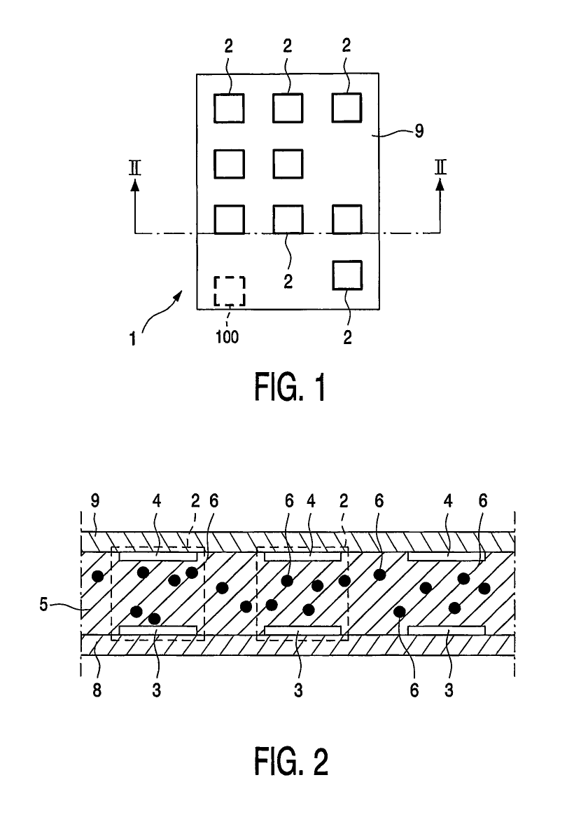

FIG. 1 shows diagrammatically a front view of an embodiment of the display panel;

FIG. 2 shows diagrammatically a cross-sectional view along II-II in FIG. 1;

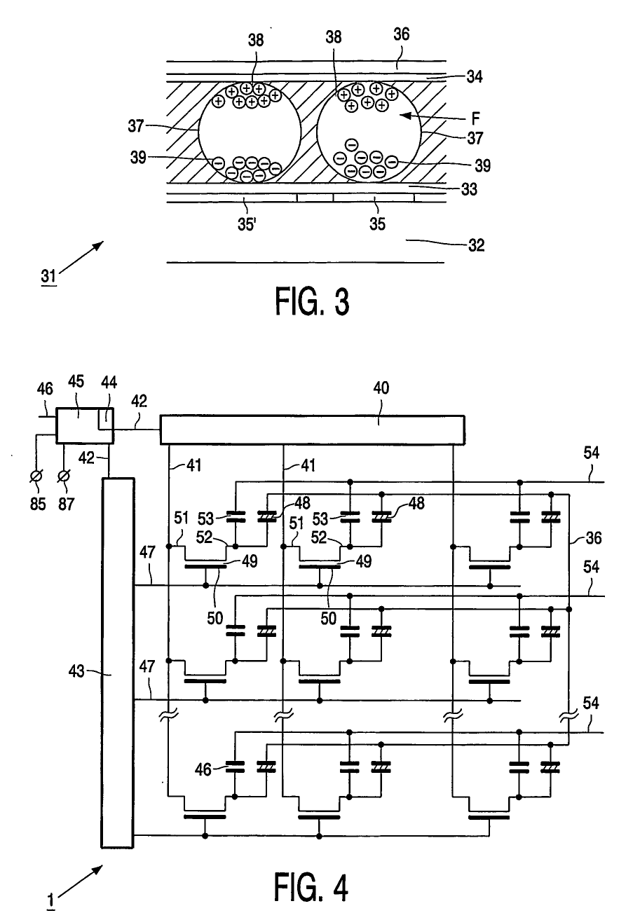

FIG. 3 shows diagrammatically a cross section of a portion of a further example of an electrophoretic display device;

FIG. 4 shows diagrammatically an equivalent circuit of a picture display device of FIG. 3;

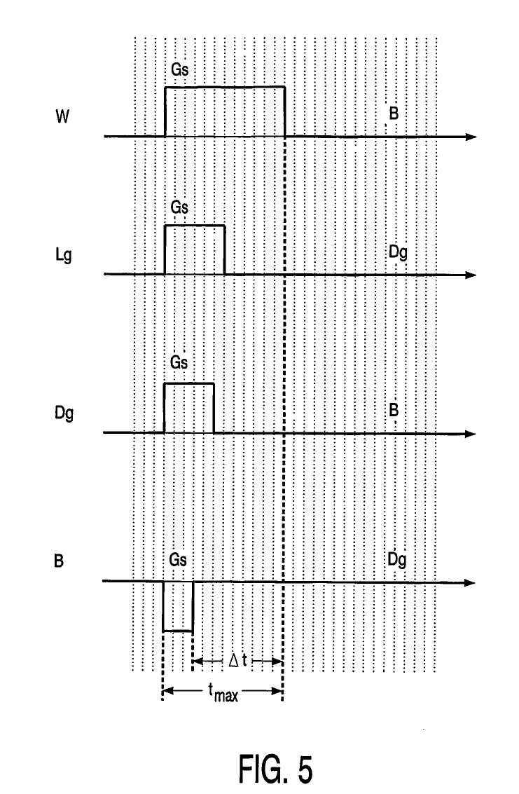

FIG. 5 illustrates by means of a driving scheme diagrammatically the potential difference as a function of time for a picture element for a driving scheme having grey scale potential differences;

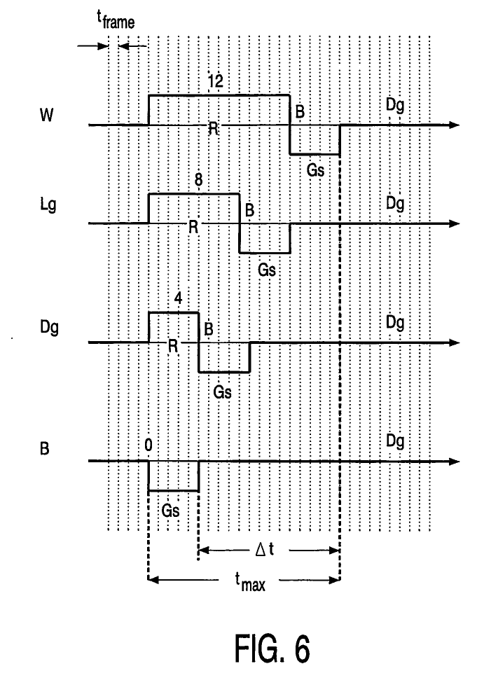

FIG. 6 illustrates by means of a driving scheme diagrammatically the potential difference as a function of time for a picture element for a driving scheme having reset and grey scale potential differences;

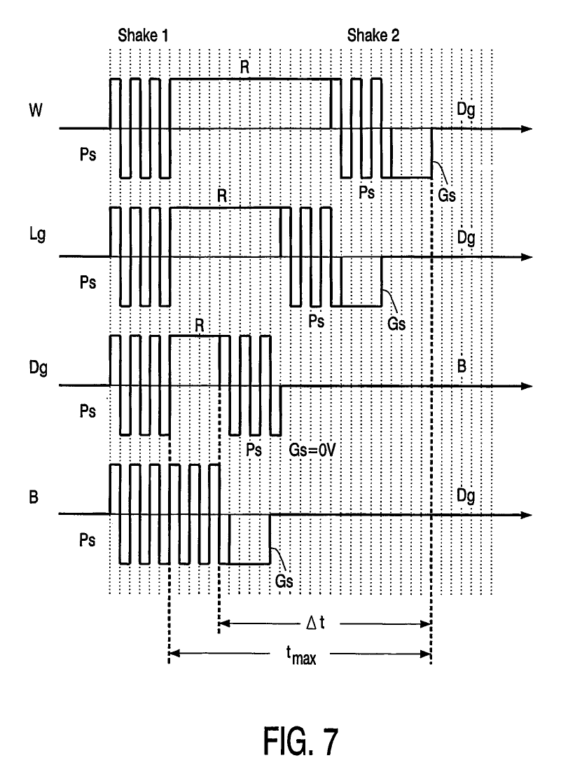

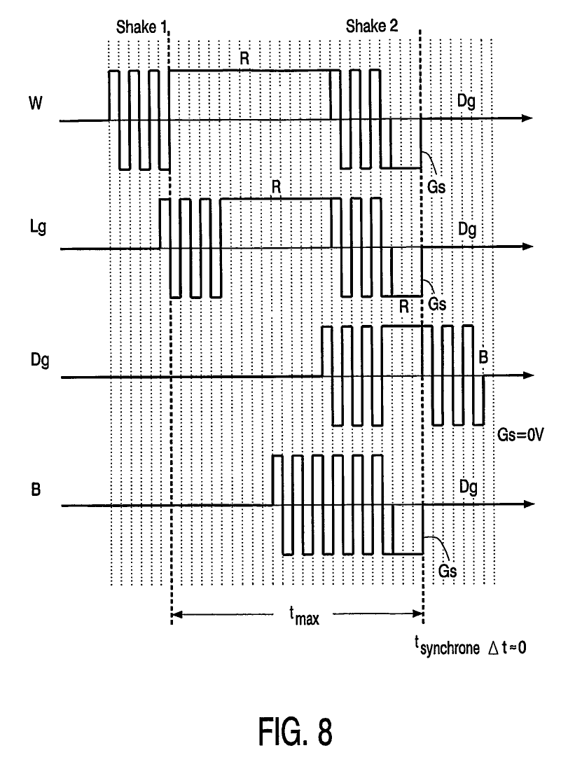

FIG. 7 illustrate by means of a driving scheme diagrammatically the potential difference as a function of time for a picture element for a driving scheme having reset, grey scale and preset potential differences; FIG. 8 illustrates by means of driving schemes a device and method in accordance with the invention;

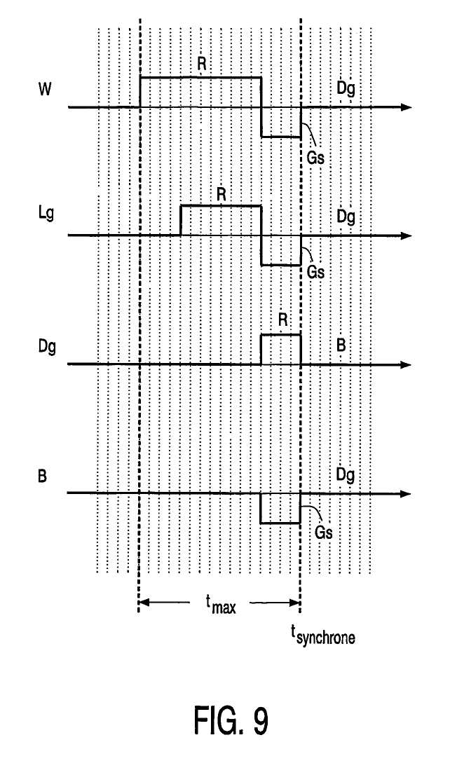

FIG. 9 illustrates by means of driving schemes a further example of a device and method in accordance with the invention;

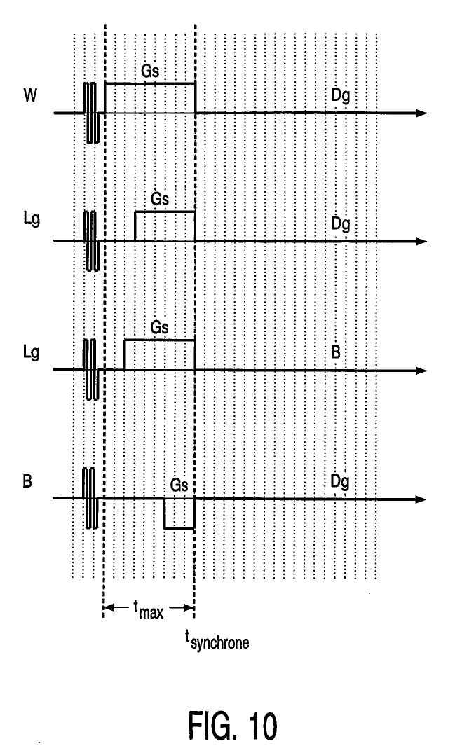

FIG. 10 illustrates by means of driving schemes a further example of a device and method in accordance with the invention;

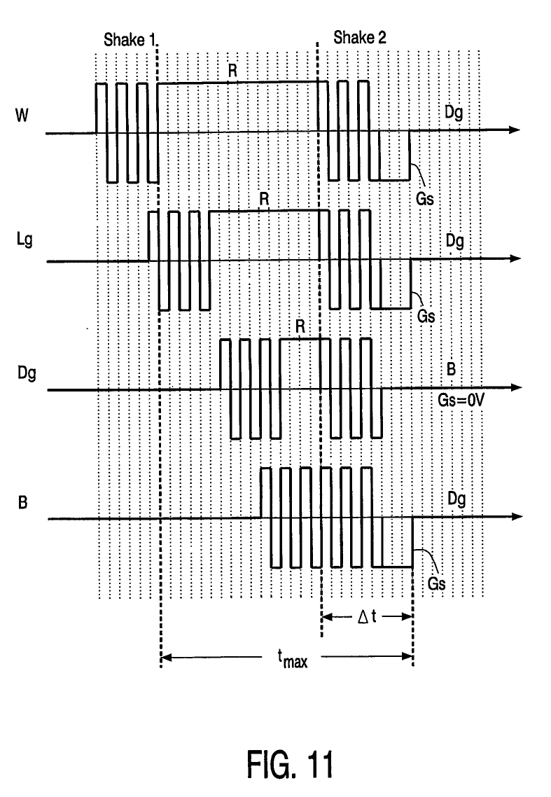

FIG. 11 illustrates by means of driving schemes a further example of a device and method in accordance with the invention, in which the end of the reset pulse is synchronized.

In all the Figures corresponding parts are usually referenced to by the same reference numerals.

FIGS. 1 and 2 show an embodiment of the display panel 1 having a first substrate 8, a second opposed substrate 9 and a plurality of picture elements 2. Preferably, the picture elements 2 are arranged along substantially straight lines in a two-dimensional structure. Other arrangements of the picture elements 2 are alternatively possible, e.g. a honeycomb arrangement. An electrophoretic medium 5, having charged particles 6, is present between the substrates 8,9. A first and a second electrode 3,4 are associated with each picture element 2. The electrodes 3,4 are able to receive a potential difference. In FIG. 2 the first substrate 8 has for each picture element 2 a first electrode 3, and the second substrate 9 has for each picture element 2 a second electrode 4. The charged particles 6 are able to occupy extreme positions near the electrodes 3,4 and intermediate positions in between the electrodes 3,4. Each picture element 2 has an appearance determined by the position of the charged particles 6 between the electrodes 3,4 for displaying the picture. Electrophoretic media 5 are known per se from e.g. U.S. Pat. No. 5,961,804, U.S. Pat. No. 6,120,839 and U.S. Pat. No. 6,130,774 and can e.g. be obtained from E Ink Corporation. As an example, the electrophoretic medium 5 comprises negatively charged black particles 6 in a white fluid. When the charged particles 6 are in a first extreme position, i.e. near the first electrode 3, as a result of the potential difference being e.g. 15 Volts, the appearance of the picture element 2 is e.g. white. Here it is considered that the picture element 2 is observed from the side of the second substrate 9. When the charged particles 6 are in a second extreme position, i.e. near the second electrode 4, as a result of the potential difference being of opposite polarity, i.e. −15 Volts, the appearance of the picture element 2 is black. When the charged particles 6 are in one of the intermediate positions, i.e. in between the electrodes 3,4, the picture element 2 has one of the intermediate appearances, e.g. light gray, middle gray and dark gray, which are gray levels between white and black. The drive means 100 are arranged for controlling the potential difference of each picture element 2 to be a reset potential difference having a reset value and a reset duration for enabling particles 6 to substantially occupy one of the extreme positions, and subsequently to be a grey scale potential difference for enabling the particles 6 to occupy the position corresponding to the image information.

FIG. 3 diagrammatically shows a cross section of a portion of a further example of an electrophoretic display device 31, for example of the size of a few display elements, comprising a base substrate 32, an electrophoretic film with an electronic ink which is present between two transparent substrates 33, 34 for example polyethylene, one of the substrates 33 is provided with transparent picture electrodes 35 and the other substrate 34 with a transparent counter electrode 36. The electronic ink comprises multiple micro capsules 37, of about 10 to 50 microns. Each micro capsule 37 comprises positively charged white particles 38 and negative charged black particles 39 suspended in a fluid F. When a positive field is applied to the pixel electrode 35, the white particles 38 move to the side of the micro capsule 37 directed to the counter electrode 36 and the display element become visible to a viewer. Simultaneously, the black particles 39 move to the opposite side of the microcapsule 37 where they are hidden to the viewer. By applying a negative field to the pixel electrodes 35, the black particles 39 move to the side of the micro capsule 37 directed to the counter electrode 36 and the display element become dark to a viewer (not shown). When the electric field is removed the particles 38, 39 remain in the acquired state and the display exhibits a bi-stable character and consumes substantially no power.

FIG. 4 shows diagrammatically an equivalent circuit of a picture display device 31 comprising an electrophoretic film laminated on a base substrate 32 provided with active switching elements, a row driver 43 and a column driver 40. Preferably, a counter electrode 36 is provided on the film comprising the encapsulated electrophoretic ink, but could be alternatively provided on a base substrate in the case of operation using in-plane electric fields. The display device 31 is driven by active switching elements, in this example thin film transistors 49. It comprises a matrix of display elements at the area of crossing of row or selection electrodes 47 and column or data electrodes 41. The row driver 43 consecutively selects the row electrodes 47, while a column driver 40 provides a data signal to the column electrode 41. Preferably, a processor 45 firstly processes incoming data 46 into the data signals. Mutual synchronisation between the column driver 40 and the row driver 43 takes place via drive lines 42. Select signals from the row driver 43 select the pixel electrodes via the thin film transistors 49 whose gate electrodes 50 are electrically connected to the row electrodes 47 and the source electrodes 51 are electrically connected to the column electrodes 41. A data signal present at the column electrode 41 is transferred to the pixel electrode 52 of the display element coupled to the drain electrode via the TFT. In the embodiment, the display device of FIG. 3 also comprises an additional capacitor 53 at the location at each display element. In this embodiment, the additional capacitor 53 is connected to one or more storage capacitor lines 54. Instead of TFT other switching elements can be applied such as diodes, MIM's, etc.

As an illustration of devices, methods and driving schemes not using reset pulses FIG. 5 illustrates driving schemes in which for the transition of a grey scale to another grey scale single drive pulse is used. The initial (starting) optical position (i.e. grey scale, e.g white, black, light grey dark grey) is given at the left hand side of the figure. The driving pulse is schematically given and at the right hand side the resulting grey scale is given. In the example of FIG. 5 a single grey scale potential difference is applied. The end of the application of grey scale potential differences is, for different transitions different, leading to a time difference Δt between the final appearance of the image at different element, dependent on the grey scale difference between images. This gives the transition form one image to another a bitty or jerky appearance. Δt is typically 75% or more of the maximum transition period tₘₐₓ, i.e. the maximum time period starting from the first application of the grey scale potential to the end of the grey scale potential This effect is even greater when reset potential differences are applied. The advantage of the application of reset potentials is that a more accurate grey scale rendition is possible.

As an example (see FIG. 6) the appearance of a picture element of a subset is white (W), light gray (Lg), dark grey (Dg) or black (B), before application of the reset potential difference. Furthermore, the picture appearance corresponding to the image information of the same picture element is dark gray. For these example, the potential difference of the picture element is shown as a function of time in FIG. 5. The reset potential difference (R) has e.g. a value of 15 Volts during resetting, i.e. during reset period. The maximum reset duration in these example is for instance 12 frame times, e.g. if the frame time is 25 msec corresponding to a total image update time of 300 ms. The reset time period is 0 frame periods (for resetting black to black), 4 frame periods (for resetting dark grey to black), 8 frame periods (for resetting light grey to black up to 12 frame periods (for resetting white to black). As a result, after application of the reset potential, each picture element has an appearance being substantially black, denoted as B. The grey scale potential difference (Gs) is applied after application of the reset pulse and is e.g. −15 Volts and a duration of in this example 4 frame times, which in this example is approximately 100 msec. As a result the picture element has, after application of the grey scale potential difference, an appearance being dark gray (G1), for displaying the picture. The examples of driving schemes shown in FIG. 6, all end at different times for different transitions showing driving schemes compared to FIG. 5 the spread Δt is even increased and is thus also more than 75% of the maximum transition time tₘₐₓ.

As explained above, the accuracy of the greyscales in electrophoretic displays is strongly influenced by image history, dwell time, temperature, humidity, lateral inhomogeneity of the electrophoretic foils etc. Using reset pulses accurate grey levels can be achieved since the grey levels are always achieved either from reference black (B) or from reference white state (W) (the two extreme states).

A disadvantage of the present display is that it exhibits an underdrive effect which lead to inaccurate grey scale reproduction. This underdrive effect occurs, for example, when an initial state of the display device is black and the display is periodically switched between the white and black state. For example, after a dwell time of several seconds, the display device is switched to white by applying a negative field for an interval of 200 ms. In a next subsequent interval no electric field is applied for 200 ms and the display remains white and in a next subsequent interval a positive field is applied for 200 ms and the display is switched to black. The brightness of the display as a response of the first pulse of the series is below the desired maximum brightness, which can be reproduced several pulses later. This underdrive effect is sometimes also called image retention.

One way of reducing this effect is to arrange the drive means for controlling the potential difference of each picture element to be a sequence of preset potential differences before being the reset potential difference and/or before being the grey scale potential differences. In a simple scheme the sequence of preset potential differences has preset values and associated preset durations, the preset values in the sequence alternate in sign, each preset potential difference represents a preset energy sufficient to release particles 6 present in one of the extreme positions from their position but insufficient to enable said particles 6 to reach the other one of the extreme positions. Without being bound to a particular explanation for the mechanism underlying the positive effects of application of the preset pulses, it is presumed that the application of the preset pulses increases the momentum of the electrophoretic particles and thus shortens the switching time, i.e the time necessary to accomplish a switch-over, i.e. a change in appearance. It is also possible that after the display device is switched to a predetermined state e.g. a black state, the electrophoretic particles are “frozen” by the opposite ions surrounding the particle. When a subsequent switching is to the white state, these opposite ions have to be timely released, which requires additional time. The application of the preset pulses speeds up the release of the opposite ions thus the de-freezing of the electrophoretic particles and therefore shortens the switching time.

FIG. 7 illustrates a set of driving schemes comparable to the one shown in FIG. 6, the difference being that preset potential differences, i.e. a series of short AC pulses are applied prior to application of reset and/or grey scale potential differences. The application of such preset (also called “shaking” pulses, which is the reason why in this figure mention is made of “shaking 1” and “shaking 2”) has the effect that the particles react faster and more accurate to application of reset or grey scale potential differences, enabling a reduction in time and/or more accurate grey scales. However, the driving schemes are, in comparison to the driving schemes of FIG. 6, and certainly in comparison to those of FIG. 5, more complex. The spread Δt is also larger than 75% of the maximum transition time tₘₐₓ.

The maximum transition time, when use is made of a reset (R) with a maximum length of Rₘₐₓ, and a preset pulse (PS) with a length PS, and a Gs pulse, with a maximum length of Gsₘₐₓ, may be calculated by tₘₐₓ=Rₘₐₓ+PS+Gsₘₐₓ. Δt is typically tₘₐₓ−PS. This leads to Δt/tₘₐₓ=(tₘₐₓ−PS)/tₘₐₓ being roughly 80-85%.

FIG. 8 illustrates a set of driving schemes in accordance with the invention.

This is illustrated for driving schemes in which reset, preset and grey scale potential differences are applied. The potential differences that determine the grey scale all end substantially at the same time t_{synchrone}, i.e. the driving schemes are synchronized. Consequently the image appears substantially at the same time. It is to be noted that in the third transition from the top (dark grey to black) there are some pulses applied after the reset pulse R, namely preset pulses PS and a grey scale potential difference Gs of 0V. However, none of these pulses influence the optical state of the element, since preset pulses shake the particles but do not substantially move them, and application of a grey scale potential difference of 0V does not have a substantial influence on the optical state. All final grey scale determining potential differences, i.e. those pulses that do influence the optical state end at the same time t_{synchrone}. In the third driving scheme from the top (Dg-B) the final grey scale determining potential difference is thus the reset pulse because in this scheme said reset pulse brings the element to an extreme optical state, which is the same as the intended optical state, since the final state is an extreme state.

The invention is equally applicable to driving schemes and devices in which only reset and grey scale potential differences are applied (FIG. 6), or only grey scale potential differences (FIG. 5).

As an illustration of such embodiment FIG. 9 show driving schemes without application of preset pulses all ending at the same instance t_{synchrone}. FIG. 9 differs from FIG. 8 in that no preset pulses are applied.

The invention is equally applicable to driving schemes and devices in which grey scale potential differences are applied preceded by a preset pulse.

As an illustration of such embodiments FIG. 10 show driving schemes without application of reset pulses all ending at the same instance t_{synchrone}.

In all of the FIGS. 8 to 10 of all the driving waveforms (i.e. the combinations of R, PS, Gs pulses) the final optical state determining potential differences (which usually is a grey scale difference, but in some driving waveforms the reset pulse, if the intended grey scale is an extreme optical state) end at the same time.

It is an object of the invention to reduce strongly Δt, and these embodiments accomplish this object as good as possible.

However, within the broader concept of the invention, a less severe condition may apply, in which the spread Δt is reduced to less than 75%/2 but there still exists a spread.

In a first class of such embodiments, in which reset and grey scale potential differences are applied the end of the reset potential differences is synchronized. FIG. 11 shows such an embodiment. As a consequence there does exits a spread Δt, as is evident from the figure, but the spread is less than 75%/2, typically approximately 33-35%. The advantage of synchronizing the end of the reset pulses is that the start of application of the grey scale potential difference (and, if present the preceding preset potential differences) is synchronized, simplifying the driving scheme. In further embodiments, additional preset pulses may be applied in portions of the potential differences where otherwise a zero volt potential would be applied. In this way, the optical performance of the display may be further improved.

It is remarked that, within the broader concept of the invention, the application of reset potential differences may encompass, and in preferred embodiments does encompass, the application of overresetting. “Overresetting” stands for methods of application of reset potentials in which purposively, at least for the transition of some grey scale state (intermediate states) reset pulses are applied which have a longer time*voltage difference than needed to drive the relevant element to the desired extreme optical state. Such overresetting may be usefull to ensure that an extreme optical state is reached, or it may be used to simplify the application scheme, such that e.g. the same length of resetting pulse is used for the resetting of different grey scale to an extreme optical state.

It is further remarked that the above-mentioned embodiments illustrate rather than limit the invention, and that those skilled in the art will be able to design many alternative embodiments without departing from the scope of the appended claims. For example, although most embodiments in accordance with the invention are described with respect to an electrophoretic ink display, the invention is also suitable for electrophoretic displays in general and for bi-stable displays. Usually, an electronic ink display comprises white and black particles which allows to obtain the optical states white, black and intermediate grey states. Although only two intermediate grey scales are shown, more intermediate grey scales are possible. If the particles have other colors than white and black, still, the intermediate states may be referred to as grey scales. The bi-stable display is defined as a display wherein the pixel substantially maintains its grey level/brightness after the power/voltage to the pixel has been removed.

Application of the various potential differences lasts usually a particular number of frame periods t_{frame}, one of which is schematically shown in FIG. 6. In embodiments the spread in t (Δt) may be one frame time.

Although in these examples pulse width modulated driving (PWM) schemes are used for illustration of this invention, it is also applicable to the driving schemes using a limited number of voltage levels combined with the PWM driving for further increasing the number of the grey levels. The electrodes may have top and bottom electrodes, honeycomb or other structures.

In short the invention can be described as follows:

An electrophoretic display device is driven by application driving waveforms comprising application of various potential differences (R, Gs, P) to bring about a change in image. In the display and method in accordance with the invention the duration of the time period (Δt) in which the end of the transition of one image to another for various waveforms occurs is less than 37.5% of the maximum time period of the waveform (Δt<0.375 tₘₐₓ), and preferably the end of the waveforms are is synchronized in time (Δt=0).

It will be appreciated by persons skilled in the art that the present invention is not limited by what has been particularly shown and described hereinabove. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

The invention is also embodied in any computer program comprising program code means for performing a method in accordance with the invention when said program is run on a computer as well as in any computer program product comprising program code means stored on a computer readable medium for performing a method in accordance with the invention when said program is run on a computer, as well as any program product comprising program code means for use in display panel in accordance with the invention, for performing the action specific for the invention. In particular, the driving schemes may be implemented in hard-ware form, in soft-ware form, or a mixture of the two.

The present invention has been described in terms of specific embodiments, which are illustrative of the invention and not to be construed as limiting. The invention may be implemented in hardware, firmware or software, or in a combination of them. Other embodiments are within the scope of the following claims.

It will be obvious that many variations are possible within the scope of the invention without departing from the scope of the appended claims.

It is remarked that use of the invention may, of course, be established by means of determining the waveforms, or analyzing the computer programs or circuits for formation of the waveforms. It is however, equally possible to measure for many pixels, the light output, i.e. the way in which the transition is made between one optical state and another, and thereby establish the spread in time and the maximum transition period.

1. An electrophoretic display device comprising electrophoretic particles (6), an array of display elements comprising a pixel electrode and a counter electrode between which a portion of the electrophoretic particles (6) are present, and control means for supplying one or more potentials differences (R, Gs, Ps) to the electrodes during a transition period to bring the display elements in a predetermined optical state (B, Lg, Dg, W) from a previous optical state to produce an image change wherein the control means for supplying one or more potential differences to the electrodes are arranged such that the one or more potential differences to bring the display elements in a predetermined optical state to produce an image on the display device end for substantially all elements of the array within a time spread period (Δt) less than 75%/2 of the maximum transition period (Δt<0.375tₘₐₓ).

2. An electrophoretic display device as claimed in claim 1, wherein the time spread period is less than 25% of the maximum transition period (Δt<0.25tₘₐₓ).

3. An electrophoretic display device as claimed in claim 2, wherein the time spread period is a frame time or less.

4. An electrophoretic display device as claimed in claim 1, wherein the control means for supplying one or more potential differences to the electrodes are arranged such that the final grey scale determining potential difference of the one or more potential differences to bring the display elements in a predetermined optical state to produce an image on the display device substantially occur at the same instance (t_{synchrone}) for substantially all elements of the array (Δt≈0).

5. An electrophoretic display device as claimed in claim 1, wherein the control means are arranged for controlling the one or more potential differences of each of the plurality of picture elements
to be a reset potential difference (R) having a reset value and a reset duration during a reset period,
and subsequently
to be a grey scale potential difference (Gs) for enabling the particles to occupy the position corresponding to image information.

6. An electrophoretic display device as claimed in claim 5, wherein the control means are arranged for applying an over-reset potential.

7. An electrophoretic display device as claimed in claim 5, wherein the control means are arranged for synchronizing the end of the reset potential differences (R).

8. An electrophoretic display device as claimed in claim 5, wherein the control means are arranged for applying in between the reset potential differences and the grey scale potential differences preset potential differences.

9. A method for driving an electrophoretic display device comprising: an electrophoretic medium (5) comprising charged particles (6);
a plurality of picture elements (2), in which method one or more potential differences (R, Gs, Ps) are applied to elements of the display device to bring the elements within a transition period in a predetermined optical state from a previous optical state to effect a change in the displayed image, wherein
application of the one or more potential differences substantially end within a time period (Δt) less than 75%/2 of the maximum transition period (Δt<0.375tₘₐₓ)

10. A method as claimed in claim 9, wherein to bring an element to a predetermined optical state from a previous optical state a reset potential difference (R) followed by a grey scale potential difference is applied, and for substantially all elements in the array application of the final grey scale determining potential difference (R, Gs) occurs at substantially the same instance (t_{synchrone}) (Δt≈0).
